(19) United States
(12) Patent Application Publication
(10) Pub. No.: US 2019/0061128 A1
(43) Pub. Date: Feb. 28, 2019

(54) Staple Gun

(71) Applicant: Steven J Hultgren, Fishers, IN (US)

(72) Inventor: Steven J Hultgren, Fishers, IN (US)

(21) Appl. No.: 16/100,576

(22) Filed: Aug. 10, 2018

Related U.S. Application Data
(60) Provisional application No. 62/549,628, filed on Aug. 24, 2017.

(51) Int. Cl. B25C 1/02

(52) U.S. Cl. CPC B25C 1/02

(57) ABSTRACT

A staple gun for driving pins into a surface. The staple gun includes a housing designed to facilitate manual actuation of a drive member, such that the drive member passes through an open interior channel in the housing to guide a bearing pin to strike a pre-positioned drive pin to penetrate through and affix itself to a surface. The drive member further includes a handle designed to receive the strike force used to actuate the drive member through the open interior channel of the housing. A spring is designed to push the handle and the drive member upward and away from the housing after each actuation of the handle, and a removable linchpin designed to restrict the range of motion of the drive member within the housing and to ensure that the drive member remains partially inserted within the housing.

### CROSS REFERENCE TO RELATED APPLICATION

This application claims the benefit of U.S. Provisional Application No. 62/549,628 filed on Aug. 24, 2017. The above identified patent application is herein incorporated by reference in its entirety to provide continuity of disclosure.

### BACKGROUND OF THE INVENTION

The present invention relates to a staple gun. More specifically, the present invention provides a method and tool For driving pins into a frame for the purpose of stabilizing the frame when mounted on a wall.

Picture frames are often hung on walls whether in a home, or office as a means of decorating the surrounding area and creating a more aesthetically appealing environment. Part of the aesthetic appeal of an arrangement of wall mounted frames is related to the relative orientation of one frame with respect to another. A single misaligned picture frame in a wall arrangement where all of the other picture frames are perfectly aligned is disturbing to the eye. For example, when a group of paintings is relatively skewed or tilted the entire arrangement can create a sense or disorganization or untidiness that reduces the overall aesthetic appeal. Maintaining an aesthetically appealing wall arrangement can be a tedious process that requires vigilant observation and readjustment of each mounted frame or wall-hanging.

The present invention provides a means of maintaining an aesthetically appealing wall arrangement without the tedium of near constant observation and readjustment. By first placing a small metal pin on the lower portion of the backside of a frame or wan-hanging, and then lightly pressing the pin into the surface of the wall the orientation of the frame or wall-hanging can be securely fixed in place. Installing the pin significantly reduces the incidence of unintentional shifts or tilts that adversely affect the orientation of the frame or wall-hanging.

Methods and tools have been disclosed in the known art that relate to stabilizing frames mounted on walls. These include methods and devices that have been patented and published in patent application publications. These methods and devices generally relate to placing adhesive on the backs of frames or installing a multitude of pins in and around the frame being mounted. However, none of these known art methods and devices provide the configuration of a manually actuated a drive member with pre-positioned drive pins disclosed by the presently claimed invention.

In light of the devices disclosed in the known art, it is submitted that the present invention substantially diverges in design elements from the known art and consequently it is clear that there is a need in the art for an improvement to existing methods and devices for stabilizing frames mounted on walls. In this regard the instant invention substantially fulfills these needs.

### SUMMARY OF THE INVENTION

In view of the foregoing disadvantages inherent in the known types of staple guns now present in the known art, the present invention provides a new staple gun wherein the same can be utilized for providing convenience for the user when stabilizing wall hangings.

It is therefore an object of the present invention to provide a new and improved staple gun device that has all of the advantages of the known art and none of the disadvantages.

It is another object of the present invention to provide a staple gun for driving pins into a frame or wall-hanging, such that the pin significantly reduces the incidence of unintentional shifts or tilts that adversely affect the orientation of the frame or wall-hanging.

Another object of the present invention is to provide a housing having an open interior channel disposed between an open first end and a second end, wherein the open first end and the open interior channel facilitate the actuation of a drive member, and the second end is fully enclosed except for a second channel configured to receive and facilitate actuation of a bearing pin.

Yet another object of the present invention is to provide a drive member having a first end removably attached to a handle, and a second end with an attached bearing pin, such that a force applied to the handle will push the drive member through the open interior channel of the housing and simultaneously push the bearing pin through the second channel of the housing.

An additional object of the present invention is to provide a spring disposed between the handle and the housing while circumscribing the drive member, such that the spring immediately pushes the handle and the drive member upward and away from the housing after each actuation of the handle.

A further object of the present invention is to provide a removable linchpin sized and proportioned to slide through a first aperture disposed on the outer surface of the housing and into a slot disposed in the body of the drive member, such that the drive member can be held in place within the housing when the linchpin is inserted.

Another object of the present invention is to provide a plurality of drive pin caps, each one having a drive pin disposed therein such that each drive in pin is inserted into the second channel and held in place directly beneath the bearing pin.

Yet still object of the present invention is to provide a staple gun that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the staple gun.

FIG. 1B shows a cross-sectional view of an embodiment of the staple gun, along line 1B′.

FIG. 1C shows a disassembled view of the components of an embodiment of the staple gun.

FIG. 2 shows a close-up view of a removal pin being inserted through a first aperture to uninstall a linchpin through a second aperture in an embodiment of the staple gun.

FIG. 3A shows a front view of a drive pin cap in an embodiment of the staple gun.

FIG. 3B shows a top-plan view of a drive pin cap in an embodiment of the staple gun.

### DETAILED DESCRIPTION OF THE INVENTION

Reference is made herein to the attached drawings. Like reference numerals are used throughout the drawings to depict like or similar elements of the staple gun. For the purposes of presenting a brief and clear description of the present invention, the preferred embodiment will be discussed as used for a staple gun. The figures are intended for representative purposes only and should not be considered to be limiting in any respect.

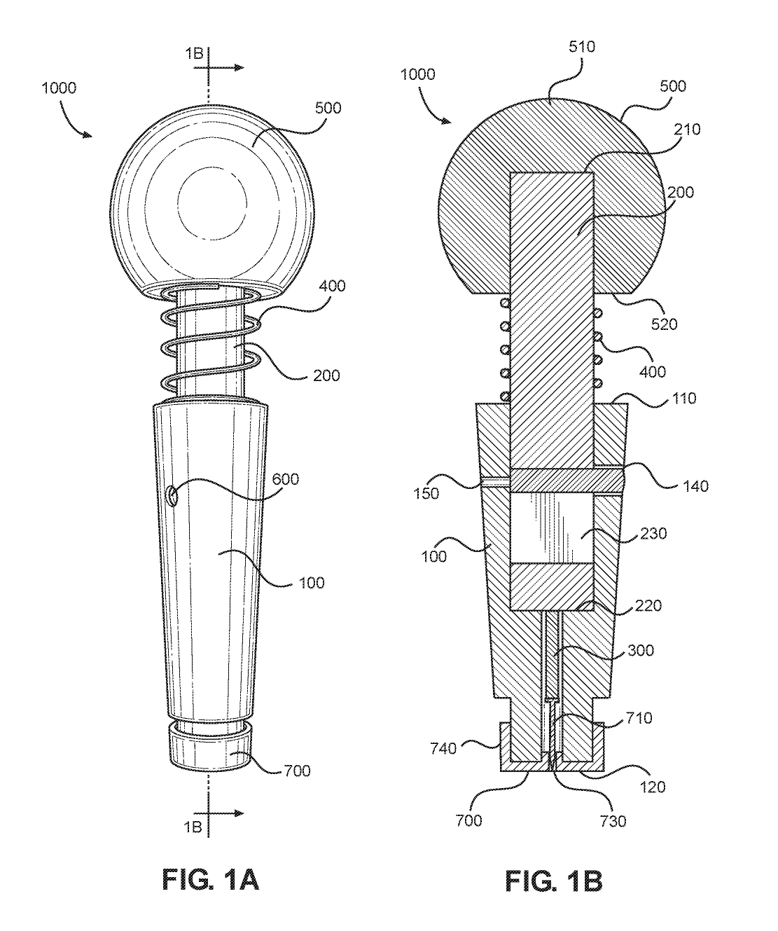

Referring now to FIGS. 1A, 1B, and 1C there are shown a perspective view, a cross-sectional view along line AA′, and a disassembled view of the components of an embodiment of the staple gun respectively. The staple gun 1000 is configured to drive pins into a surface and comprises a housing 100 having an open interior channel 115 disposed between an open first end 110 and a second end 120, wherein the open first end 110 and the open interior channel 115 are configured to facilitate actuation of a drive member 200, and the second end 120 is fully enclosed except for a pin hole sized second channel 125 configured to receive and facilitate actuation of a bearing pin 300. In some embodiments the housing 100 tapers inward such that the first end 110 is broader than the second end 120. The staple gun 1000 for driving pins into a surface also provides a plurality of drive pin caps 700, such that each one has a drive pin 710 disposed therein configured to be inserted into the second channel 125. Once inserted into the second channel 125 each drive pin 710 is held in place directly beneath the bearing pin 300 such that the drive pin 710 can be driven into a surface.

In the illustrated embodiment the drive member 200 is an elongated cylindrical member that includes a first end 210 removably attached to a handle 500, and a second end 220 with the bearing pin 300 disposed thereon, such that a force applied to the handle 500 will actuate the drive member 200 through the open interior channel 115 of the housing 100 and simultaneously actuate the bearing pin 300 through the second channel 125 of the housing 100. In this embodiment, the handle 500 includes a partial sphere 510 having a planar face 520 with an open interior channel 530 disposed therein such that the drive member 200 can be removably inserted therein, and the handle 500 is configured to withstand the strike-force used to embed a drive pin 710 into a surface. The spherical portion provides a simple and convenient means for a user to strike down on the handle bare handed and still apply uniform force downward to drive the drive member 200.

Additionally, the illustrated embodiment shows where a spring 400 circumscribes the drive member 200 while disposed between the handle 500 and the housing 100 is configured to immediately push the handle 500 and the drive member 200 upward and away from the housing 100 after each actuation of the handle 500. By pushing the handle 500 and the drive member 200 upward and away from the housing 100 after each actuation the handle is automatically reset to a position wherein the device is again ready to be used. Furthermore, a removable linchpin 600 is sized and proportioned to slide through a first aperture 140 disposed on the outer surface of the housing 100 and into a slot 230 disposed in the body of the drive member 200, such that the drive member 200 can be held in place within the housing 100 when the linchpin 600 is inserted.

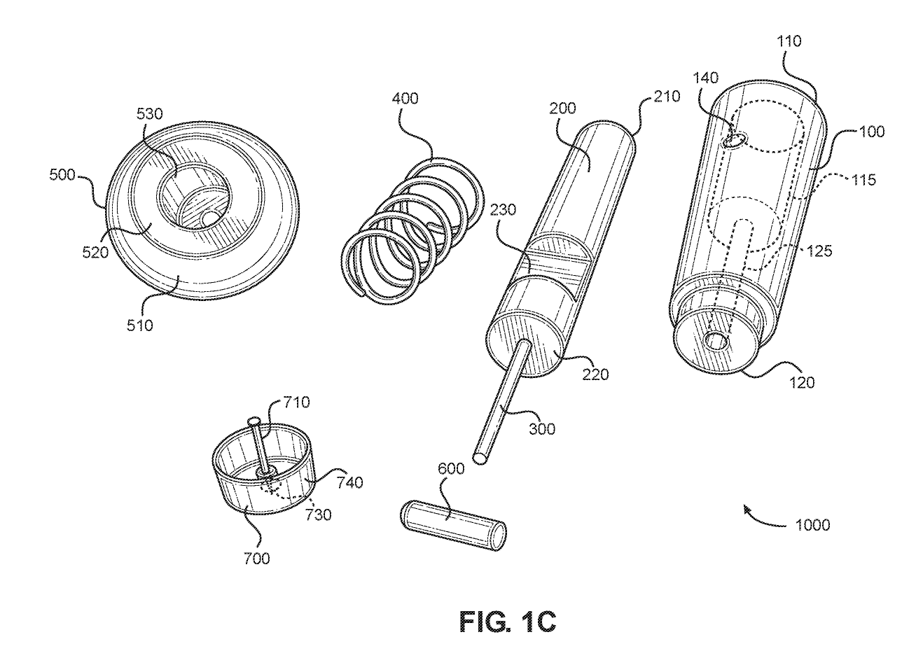

Referring now to FIG. 2 there is shown a close-up view of a removal pin being inserted through a first aperture to uninstall a linchpin through a second aperture in an embodiment of the staple gun. In the illustrated embodiment the slot 230 disposed in the drive member 200 is positioned closer to the bearing pin 300 than to the handle 100 such that when the linchpin 600 is inserted therein the drive member 200 secured within the housing 100 and the range of upward motion for the drive member 200 limited to the height of the slot 230. When the linchpin 600 is removed the drive member 200 has an unlimited range of upward motion and can be fully removed from the channel 115 of the housing 100. To remove the linchpin 600 a pin hole sized second aperture 150 is provided. The second aperture s disposed on the outer surface of the housing 100 such that a line of sight is created from the second aperture 150 through the slot 230 disposed in the drive member 200 to the first aperture 140 disposed on the outer surface of the housing 100.

In some embodiments a removal pin 800 is also provided, such that the removal pin 800 is configured to slidably insert through the second aperture 150 and push the linchpin 600 out through the first aperture 140. Additionally, the second aperture 150 is sized and proportioned to be finer than the first aperture 140 such that the removal pin 800 can pass through bother apertures 140, 150, but the linchpin 600 is prevented from completely passing through both apertures 140, 150 and remains in place to secure the drive member 200 within the channel 115 of tile housing 100.

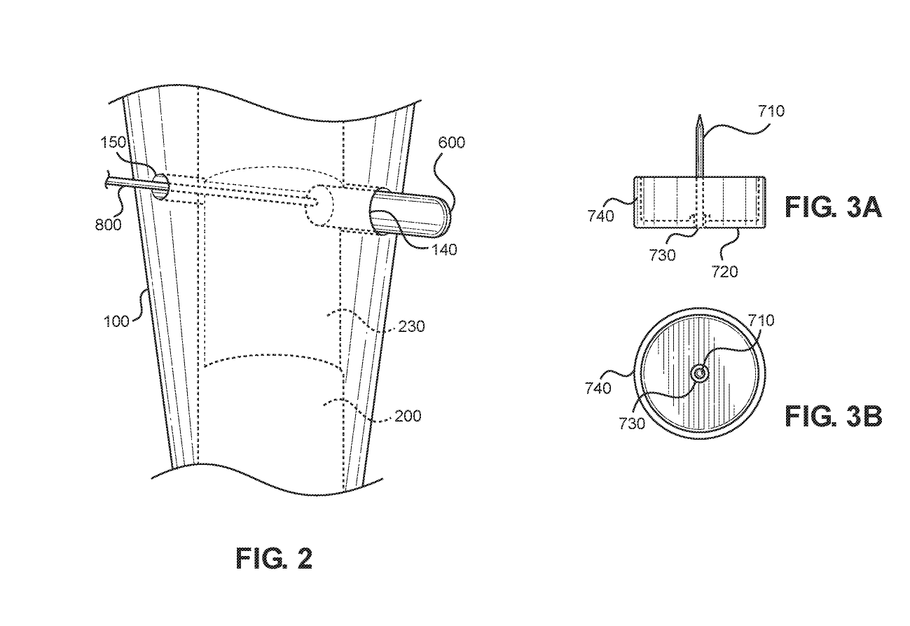

Referring now to FIGS. 3A and 3B there are shown a front view and a top-plan view of a drive rain cap in an embodiment of the staple gun, respectively. In the illustrated embodiment each drive pin cap 700 comprises a planar base 720, a central pinhole 730, a drive pin 710, and a sidewall 740, such that the drive pin 710 is removably disposed in the central pinhole 730.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact constriction and operation shown and described,and accordingly, all suitable modifications and equivalents may be resorted to, falling within the scope of the invention.

I claim:

1) A staple gun for driving pins into a surface, comprising:
a housing having an open interior channel disposed between an open first end and a second end, wherein the open first end and the open interior channel are configured to facilitate actuation of a drive member;
the drive member further includes a first end removably attached to a handle, and a second end with a bearing pin disposed thereon, such that a force applied to the handle will actuate the drive member through the open interior channel of the housing and simultaneously actuate the bearing pin through the second channel of the housing;
a spring circumscribing the drive member while disposed between the handle and the housing, is configured to push the handle and the drive member upward and away from the housing after each actuation on of the handle;
a removable linchpin is sized and proportioned to slide through a first aperture disposed on the outer surface of the housing and into a slot disposed in the body of the drive member, such that the drive member can be held in place within the housing when the linchpin is inserted;
a plurality of drive caps, each one having a drive pin disposed therein, configured to slide over the second end of the housing while holding the drive pin directly beneath the bearing pin and second channel.

2) The apparatus of claim 1, wherein the housing comprises an elongated tubular member that tapers inward such that the first end is broader than the second end.

3) The apparatus of claim 1, wherein the second end is fully closed except for a second channel configured to receive and facilitate actuation of the bearing pin.

4) The apparatus of claim 1, wherein the drive member is an elongated cylindrical member.

5) The apparatus of claim 1, wherein the second channel is pinhole sized.

6) The apparatus of claim 1, wherein the handle is a partial sphere having a planar face with an open interior channel disposed therein such that the drive member can be removably inserted therein.

7) The apparatus of claim 6, wherein the handle is configured to withstand the strike-force used to embed a drive pin into a surface.

8) The apparatus of claim 1, wherein the slot disposed in the drive member is closer to the bearing pin than the handle and provides a range of motion for the drive member when the linchpin is inserted therein.

9) The apparatus of claim 8, wherein a second aperture is disposed on the outer surface of the housing such that a line of sight s created from the second aperture through the slot disposed in the drive member to the first aperture disposed on the outer surface of the housing.

10) The apparatus of claim 9, wherein the second aperture is finer than the first aperture.

11) The apparatus of claim 9, wherein a removal pin is configured to slidably insert through the second aperture and push the linchpin out through the first aperture.

12) The apparatus of claim 1, wherein each drive cap comprises a planar base, a central pinhole, a drive pin, and a sidewall, such that the drive pin is removably disposed in the central pinhole.
